(19) United States
(12) Patent Application Publication
(10) Pub. No.: US 2008/0282847 A1
(43) Pub. Date: Nov. 20, 2008

(54) Method and Device for Positioning a Power Tong at a Pipe Joint

(76) Inventor: Helge-Ruben Halse, Kristiansand (NO)

Correspondence Address: PATTERSON & SHERIDAN, L.L.P., 3040 POST OAK BOULEVARD, SUITE 1500, HOUSTON, TX, 77056, US

(21) Appl. No.: 12/094,767

(22) PCT Filed: Nov. 23, 2006
(86) PCT No.: PCT/NO06/00425

§ 371 Date: Jul. 31, 2008

(30) Foreign Application Priority Data
Nov. 25, 2005 (NO) 20055576

(51) Int. Cl. B25B 11/00

(52) U.S. Cl. 81/57.15

(57) ABSTRACT

A method and device for positioning a power tong (2) at the pipe joint (14) of a pipe string (12), where, after the pipe joint (14) has been brought within the working area of the power tong (2), the power tong (2) must be displaced to a position that corresponds with that of the pipe joint (14), and where a camera (16) which may be displaced in parallel with the pipe (12), and which is linked to a display (18), is displaced until the image of the pipe joint (14) coincides with a marker (40) in the display, whereupon a signal is transmitted to a control (26), indicating that the power tong (2) is to be displaced to a position that corresponds with that of the camera (16) and thereby that of the pipe joint (14).

This invention regards a method of positioning a power tong at a pipe joint. More particularly, it regards a method of positioning a power tong at the pipe joint of a pipe, where, after the pipe joint has been brought within the working area of a power tong, the power tong must be displaced to a position that corresponds with that of the pipe joint. A camera which may be displaced in parallel with the pipe, and which is linked to a display, is displaced until the image of the pipe joint coincides with a marker. A signal is then transmitted to a control, indicating that the power tong is to be displaced to a position that coincides with the camera and thereby the pipe joint. Preferably, the control, which receives information about the relative positions of the camera and the power tong, is programmed to guide the power tong to said position. The invention also regards a device for implementation of the method.

When screwing together and unscrewing pipe strings, e.g. in connection with drilling in the ground, power tongs are typically used for the actual screwing operation. The positioning of the power tong, which in addition to the actual power tong also comprises a backup tong, at the pipe joint must be relatively accurate to avoid damage to the pipe couplings, and to ensure the success of the screwing operation.

A pipe string may for instance consist of drill pipes or casing. In this context, the term pipes also includes other equipment such as drill collars or tool components that are commonly connected into a pipe string.

According to prior art, the power tong is guided to the correct position by an operator near the power tong. It is also known to place sensors by the pipe string, the sensors being arranged to indicate to position of the pipe joint, so that the power tong can then automatically be guided to the correct position.

US document 2005/0 104 583 describes an apparatus for positioning pipe joints by means of so-called eddy current. Position measuring by use of an eddy current field will only provide an approximate position report, due to the relatively “blurred” change in the eddy current field at the approach of the pipe joint.

Safety reasons dictate that preferably, personnel should not be present on the drill floor during the operations in question. Furthermore, sensors have turned out not to be capable of indicating the position of the pipe joint with sufficient accuracy. The reason for this is, among other things, that the sensors can hardly take into account the fact that the pipe components have been repaired or for other reasons have different dimensions.

The object of the invention is to remedy or reduce at least one of the drawbacks of prior art.

The object is achieved in accordance with the invention, by the features stated in the description below and in the following claims.

When positioning a power tong at the pipe joint of a pipe, where, after the pipe joint has been brought within the working area of the power tong, the power tong must be displaced to a position that corresponds with that of the pipe joint, a camera which may be displaced in parallel with the pipe, and which is linked to a display, is displaced in the direction of the pipe joint until the image of the pipe joint coincides with a marker. A signal is then transmitted to a control, indicating that the power tong is to be displaced to a position that coincides with the camera and thereby the pipe joint, the control, which receives information about the relative positions of the camera and the power tong, preferably being programmed to guide the power tong to said position.

The marker, which preferably appears in the display, may be e.g. crosshairs in the display, in the camera optics or an electronically generated marker.

Preferably, the camera, which is directed at the pipe string, can be displaced along a guide by means of an actuator. The guide is secured to a point at a fixed height relative to the power tong. The actuator may be an electric motor coupled to a feed screw, or it may be a hydraulic cylinder. The actuator is controlled by a first transducer, preferably via the control.

The display, which displays an image of the pipe string at the current vertical height of the camera, is placed near the first transducer to allow an operator to operate the first transducer based on what can be seen in the display.

Preferably, upon receiving a signal from the first transducer indicating that the camera is in the correct position by the pipe joint, the control will automatically guide the power tong to the desired position by the pipe joint.

The method and device of the invention provides a reliable, remote controlled and relatively favourably priced solution for positioning a power tong at a pipe joint.

The following describes a non-limiting example of a preferred method and embodiment illustrated in the accompanying drawings, in which:

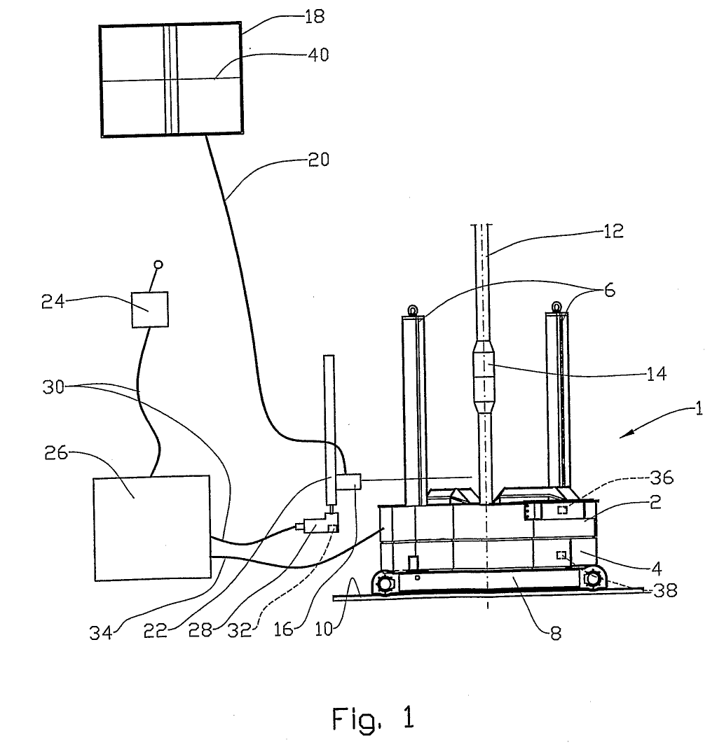

FIG. 1 is a schematic view of a power tong in an idle position, and where a pipe joint is placed inside the working area of the power tong;

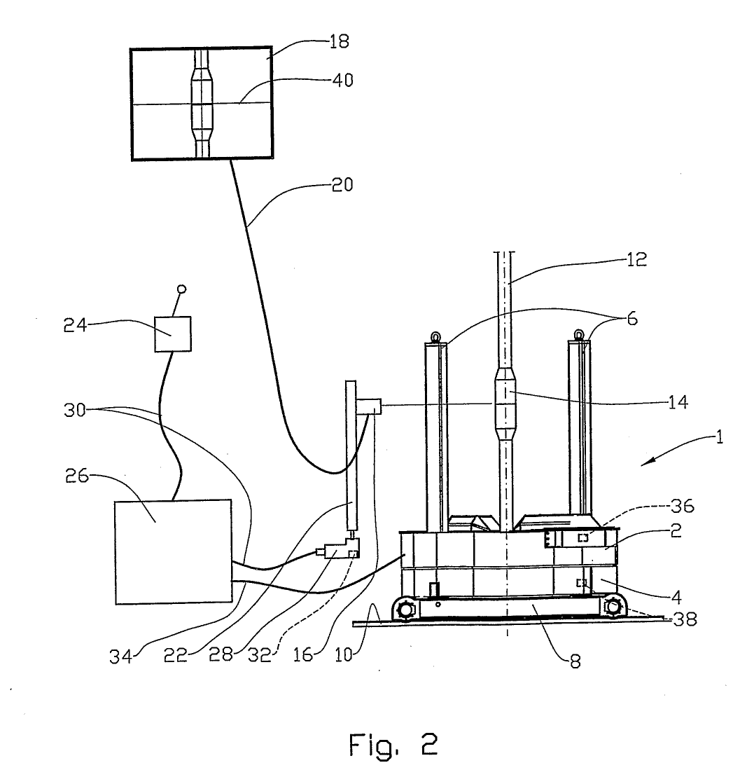

FIG. 2 is similar to FIG. 1, but here a camera has been displaced to a position that corresponds with that of the height of the pipe joint, an image of the pipe joint in a connected display coinciding with a marker in the display; and

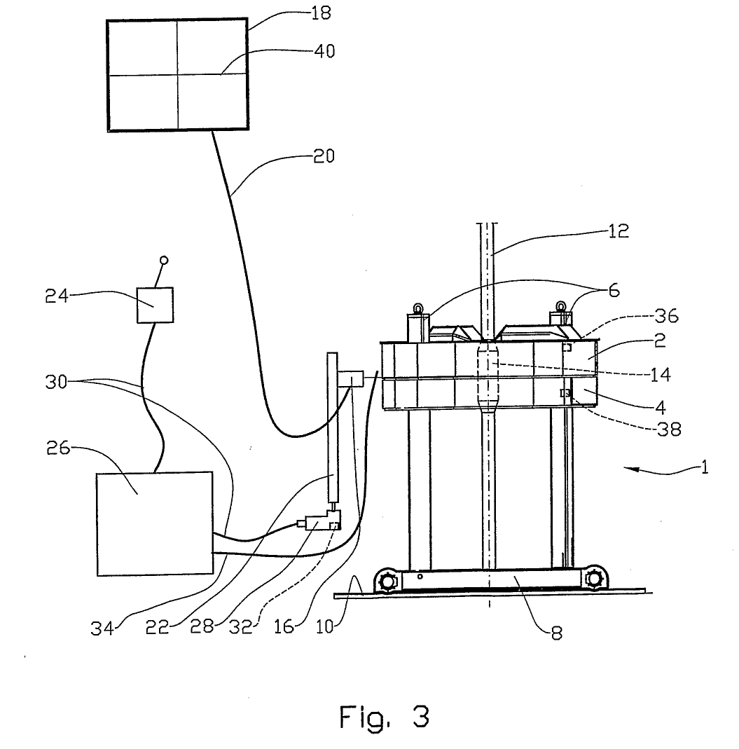

FIG. 3 is a schematic view of the power tong displaced to a position that corresponds with that of the camera, the power tong also being in a desired position relative to the pipe joint.

In the drawings, reference number 1 denotes an assembly of a power tong 2 and a backup tong 4 arranged jointly or separately to move vertically along columns 6. The columns 6 are mounted on a pedestal 8, and the entire assembly 1 can be displaced on a drill floor 10.

A pipe string 12 extends through the assembly 1. Together, the power tong 2 and the backup tong 4 are arranged to make up and break the pipe joints 14 of the pipe string 12 by the tongs 2, 4 being placed on separate parts of the pipe joint 14 and gripping the pipe as the power tong 2 rotates the upper part of the pipe string 12 in the desired direction while the backup tong 4 holds the other part of the pipe string 12 still.

A camera 16 connected to a display 18 by a line 20 is directed at the pipe string 12, the display 18 showing an image of the pipe string 12.

The camera 16 can be displaced, preferably in parallel with the pipe string 12, by means of a guide 22. The camera 16 is controlled by a first transducer 24, a programmable control 26 and a motor 28 by means of a feed screw (not shown). Lines 30 connect the first transducer 24 and the motor 28 to the control 26.

The motor 28 is provided with a second transducer 32, which in a manner that is known per se is arranged to deliver a signal to the control 26, so that the control 26 can keep track of the relative position of the camera 16.

The control 26 is connected to the power tong 2 and the backup tong 4 via a line 34. The control 26 is arranged to control the displacement of the tongs 2, 4 along the columns 6, and also to keep track of the relative positions of the tongs 2, 4 by means of signals from a third transducer 36 and a fourth transducer 38.

When the pipe joint 14 of the pipe string 12 is within the working area of the tongs 2, 4, see FIG. 1, the first transducer 24 is operated, whereupon the camera 16 is displaced in the direction of the pipe joint 14 until the pipe joint 14, more particularly visible break between the parts of the pipe joint 14, coincides with a marker 40 in the display 18, see FIG. 2.

Then a signal is transmitted to the control 26 via the first transducer 24, instructing the tongs 2, 4 to move, preferably automatically, along the pipe string 12 to a position that corresponds with that of the camera 16. This position coincides with the position of the pipe joint 14; see FIG. 3, whereupon a pipe string portion can be uncoupled from a pipe string 12 in a manner that is known per se.

1. A method of positioning a power tong at the pipe joint of a pipe string, where, after the pipe joint has been brought within the working area of the power tong, the power tong must be displaced to a position that corresponds with that of the pipe joint, characterized in that a camera that can be displaced in parallel with the pipe, and which is linked to a display, is displaced until the image of the pipe joint coincides with a marker, whereupon a signal is transmitted to a control, indicating that the power tong is to be displaced to a position that corresponds with that of the camera and thereby the pipe joint.

2. A method in accordance with claim 1, characterized in that the control, which receives information about the relative positions of the camera and the power tong, automatically guides the power tong to the correct position.

3. A positioning device for a power tong at the pipe joint of a pipe string, where, after the pipe joint has been brought within the working area of the power tong, the power tong must be displaced to a position that corresponds with that of the pipe joint, characterized in that the positioning device comprises a camera that can be displaced in parallel with the pipe, which is linked to a display, and which is arranged to be displaced until the image of the pipe joint coincides with a marker in the display, and where a first transducer connected to a control for the power tong is arranged to transmit a signal to the control to displace the power tong to a position that corresponds with that of the pipe joint.

4. A device in accordance with claim 3, characterized in that the camera can be displaced by an actuator.

5. A device in accordance with claim 4, characterized in that the camera can be displaced by an electric motor.

6. A device in accordance with claim 4, characterized in that the camera can be displaced by a hydraulic cylinder.
